(19) United States
(12) Patent Application Publication
(10) Pub. No.: US 2020/0270919 A1
(43) Pub. Date: Aug. 27, 2020

(54) Hold Open Rod Having a Lock Mechanism for Securely Locking the Hold Open Rod in an Extended Configuration

(71) Applicant: MarathonNorco Aerospace, Inc., Waco, TX (US)

(72) Inventors: Benjamin Dyer, Waco, TX (US); Jacob Klos, Waco, TX (US)

(21) Appl. No.: 16/797,056

(22) Filed: Feb. 21, 2020

Related U.S. Application Data
(60) Provisional application No. 62/808,448, filed on Feb. 21, 2019.

(51) Int. Cl. E05C 17/22; E05C 17/18

(52) U.S. Cl. CPC E05C 17/22; E05C 17/18; E05Y 2900/502; E05Y 2201/22; E05Y 2201/264; E05Y 2201/474

(57) ABSTRACT

A hold open rod includes a rail configured to be attached to a structure. The rail including at least one surface having engagement portions. The hold open rod also includes a lock mechanism configured to be attached to the rail, the lock mechanism configured to allow the rail to move in a first direction. The lock mechanism further configured to prevent the rail from moving in a second direction by engaging with the engagement portions.

### CROSS-REFERENCE TO RELATED APPLICATIONS

This application claims the benefit of U.S. Provisional Application No. 62/808,448 filed on Feb. 21, 2019, which is hereby incorporated by reference in its entirety for all purposes as if fully set forth herein.

### FIELD OF THE DISCLOSURE

The disclosure relates to a hold open rod having a lock mechanism for securely locking the hold open rod. More particularly, the disclosure relates to a hold open rod having a lock mechanism for securely locking the hold open rod in an extended configuration. The disclosure further relates to a process of implementing a hold open rod having a lock mechanism for securely locking the hold open rod. More particularly, the disclosure relates to a process of implementing a hold open rod having a lock mechanism for securely locking the hold open rod in an extended configuration.

### BACKGROUND OF THE DISCLOSURE

Hold open rods are well known in both the automotive and aviation industries. Hold open rods may be used to hold a component, such as door, hatch, or the like in an open configuration after the component has been opened manually or automatically. A typical hold open rod supports a considerable amount of weight or force when locked in an open position. Once unlocked, the typical hold open rod allows movement of the component to a closed position.

Hold open rods may be implemented in applications that include structures that may be configured to move or be repositioned during certain critical events. During these critical events where structures are moved, opened, and/or repositioned, it may be beneficial to utilize a hold open rod to automatically lock and hold these structures in their repositioned configurations. For example, the structures may be moved or repositioned during a critical event related to emergency actuation. This emergency actuation may be subjected to high levels of aerodynamic forces or other forces. However, prior art hold open rods have been found to be insufficient and/or inadequate to operate during these critical events to maintain the structures in an emergency extended configuration due to the high level aerodynamic forces and/or other forces.

Accordingly, a device and process to allow extension and locking of a hold open rod during critical events is needed to increase the safety and improve operation of an associate vehicle.

### SUMMARY OF THE DISCLOSURE

The foregoing needs are met, to a great extent, by the disclosure, wherein in one aspect a device and process are provided for a hold open rod having a lock mechanism for securely locking the hold open rod in an extended configuration.

One general aspect includes a hold open rod including a rail configured to be attached to a structure; the rail including at least one surface having engagement portions; a lock mechanism configured to be attached to the rail; the lock mechanism configured to allow the rail to move in a first direction. The lock mechanism further configured to prevent the rail from moving in a second direction by engaging with the engagement portions.

One general aspect includes a hold open rod including a rail configured to be attached to a structure; the rail including at least one surface having engagement portions; a ratcheting lock mechanism configured to be attached to the rail, the ratcheting lock mechanism configured to allow the rail to move in a first direction. The ratcheting lock mechanism further configured to prevent the rail from moving in a second direction by engaging with the engagement portions.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a perspective view of a hold open rod according to the disclosure.

FIG. 2 illustrates a side view of the hold open rod according to FIG. 1.

FIG. 3 illustrates a bottom view of the hold open rod according to FIG. 1.

FIG. 4 illustrates a top view of the hold open rod according to FIG. 1.

FIG. 5 illustrates a partial perspective view of a lock mechanism according to an aspect of the disclosure.

FIG. 6 illustrates a partial side view of the lock mechanism of FIG. 5 in an unlocked configuration.

FIG. 7 illustrates a partial side view of the lock mechanism of FIG. 5 in a locked configuration.

FIG. 8 illustrates a partial side view of the lock mechanism of FIG. 5.

FIG. 9 illustrates a partial side view of the lock mechanism of FIG. 5.

FIG. 10 illustrates a partial top view of a rail according to an aspect of the disclosure.

FIG. 11 illustrates a partial top view of a rail according to another aspect of the disclosure.

FIG. 12 illustrates a hold open rod system according to an aspect of the disclosure.

### DETAILED DESCRIPTION

The disclosure will now be described with reference to the drawing figures, in which like reference numerals refer to like parts throughout. Aspects of the disclosure advantageously provide a hold open rod having a lock mechanism for securely locking the hold open rod in an extended configuration.

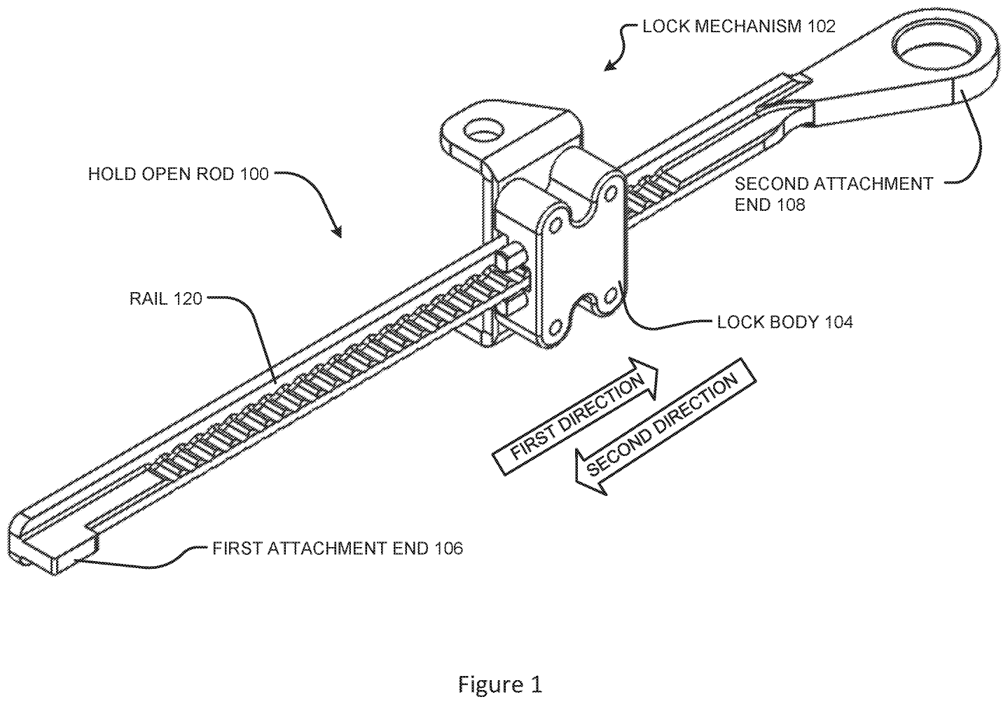

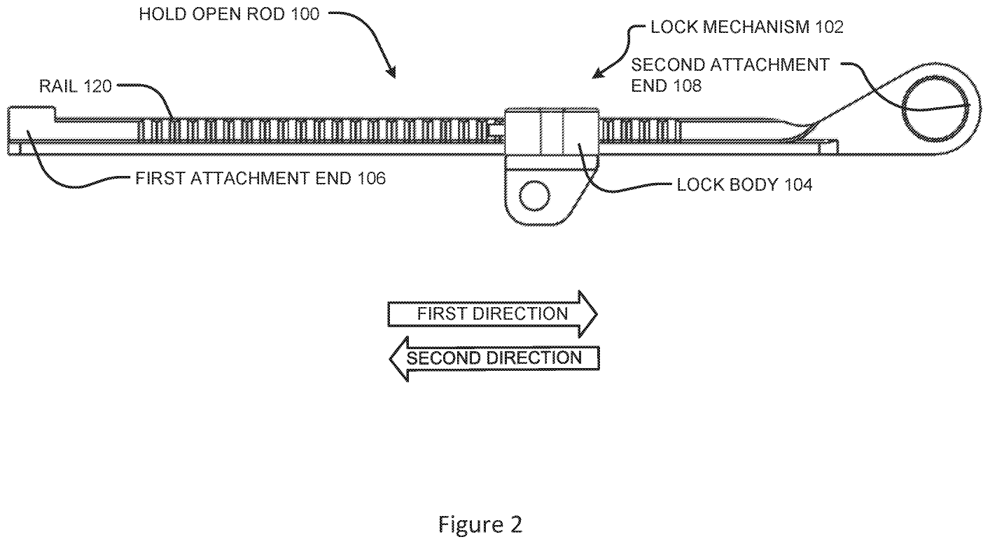

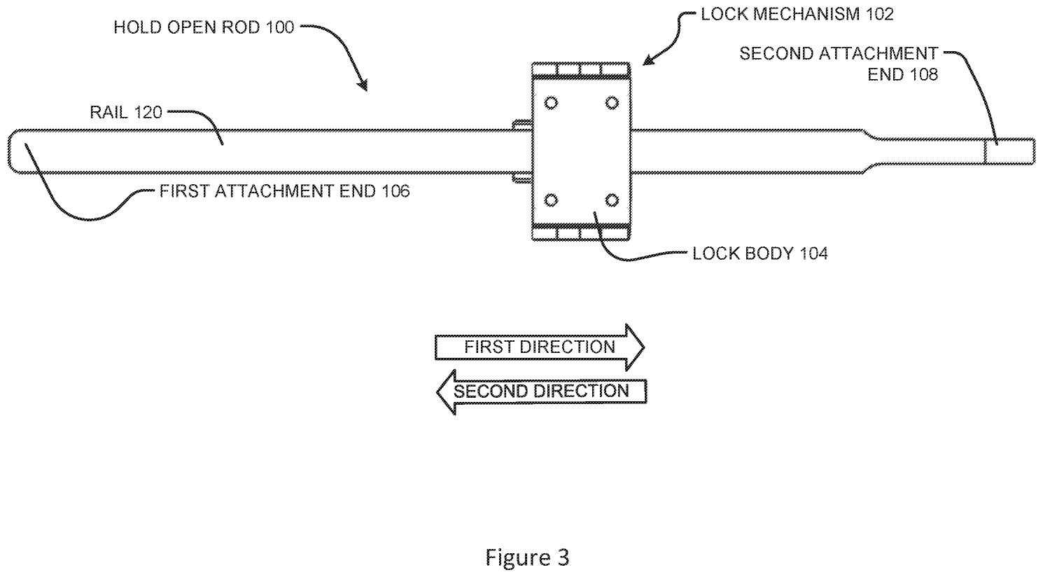

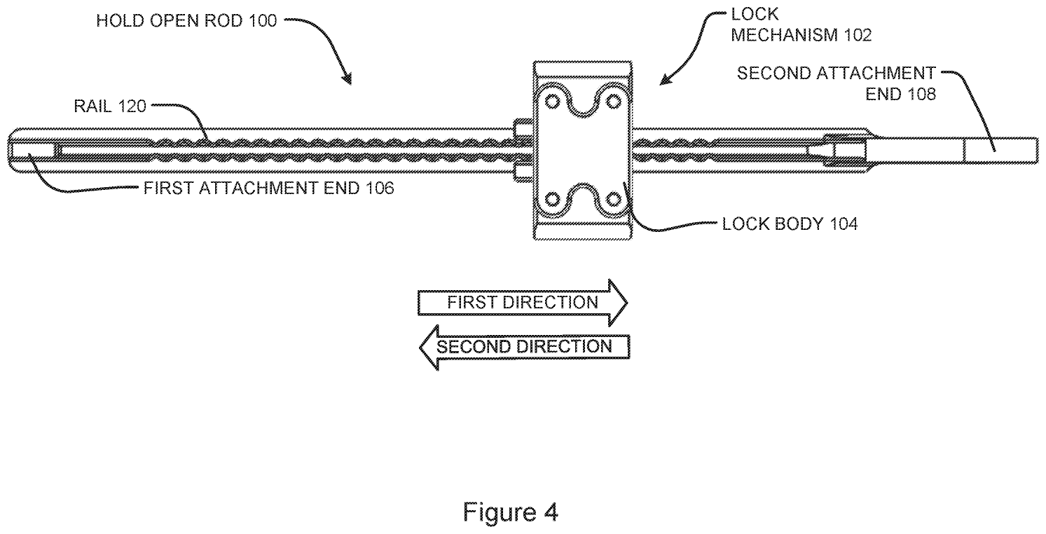

FIG. 1 illustrates a perspective view of a hold open rod according to the disclosure; FIG. 2 illustrates a side view of the hold open rod according to FIG. 1; FIG. 3 illustrates a bottom view of the hold open rod according to FIG. 1; and FIG. 4 illustrates a top view of the hold open rod according to FIG. 1.

In particular, FIG. 1, FIG. 2, FIG. 3, and FIG. 4 illustrate a hold open rod 100 having a rail 120. As illustrated, the rail 120 may have a T-shaped cross-section. In other aspects, the rail may have a D-shaped cross-section. In other aspects, the rail may have a I-shaped cross-section (I-Beam). In other aspects, the rail may have a L-shaped cross-section, a C-shaped cross-section, a square shaped cross-section, a circular shaped cross-section, and/or the like. It should be noted that any cross-sectional shape may be utilized for the rail 120 to provide sufficient rigidity, strength, and the like. The rail 120 may be formed of a metallic material such as steel, aluminum, titanium, or the like. The rail 120 may additionally or alternatively be formed of a synthetic material such as a plastic, or the like. The rail 120 may additionally or alternatively be formed of a composite material that includes carbon fiber, Kevlar fiber, glass fiber, or the like.

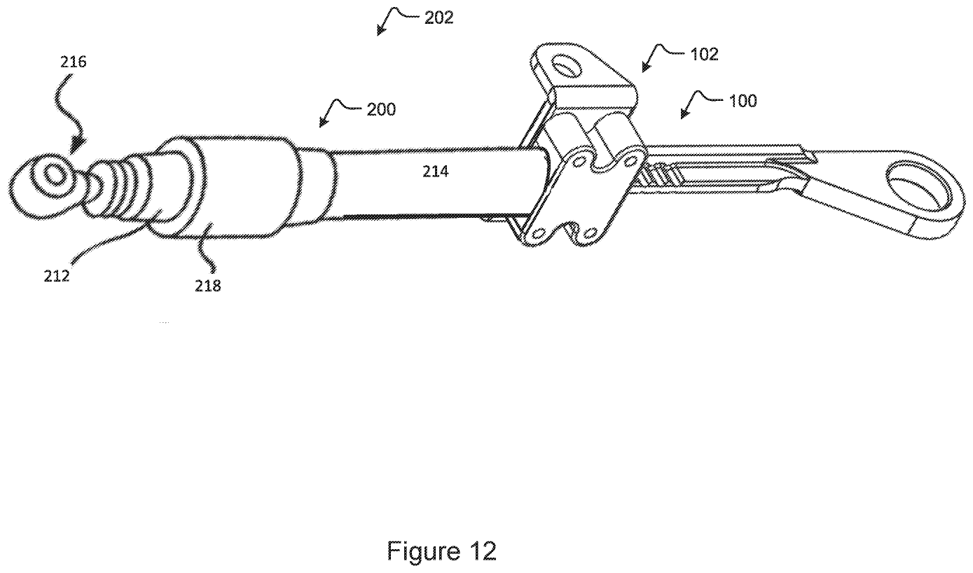

The rail 120 may include a first attachment end 106 that may be configured to connect to a structure. The structure may be an aircraft structure, a vehicle structure, a building structure, or the like. In one aspect, the structure may be a movable structure such as a door, cowling, access panel, or the like. Alternatively, the first attachment end 106 may attach to another hold open rod as illustrated in FIG. 12 that may attach to the structure. Alternatively, the first attachment end 106 may attach to another component. Additionally, the first attachment end 106 may be configured to attach to the structure utilizing a mechanical fastener such as a bolt, screw, rivet, or the like. In this regard, the first attachment end 106 may be configured with a hole, aperture, threads, or the like implemented for use in conjunction with the mechanical fastener such as a bolt, screw, rivet, or the like.

The rail 120 may include a second attachment end 108 that may be configured to connect to a structure. The structure may be an aircraft structure, a vehicle structure, a building structure, or the like. In one aspect, the structure may be a movable structure such as a door, cowling, access panel, or the like. Alternatively, the second attachment and 108 may attach to another hold open rod as illustrated in FIG. 12 that may attach to the structure. Alternatively, the second attachment and 108 may attach to another component. Additionally, the second attachment end 108 may be configured to attach to the structure utilizing a mechanical fastener such as a bolt, screw, rivet, or the like. In this regard, the second attachment end 108 may be configured with a hole, aperture, threads, or the like implemented for use in conjunction with the mechanical fastener such as a bolt, screw, rivet, or the like.

The hold open rod 100 may further include a lock mechanism 102. The lock mechanism 102 may be configured to allow the rail 120 to move with respect to the lock mechanism 102 in a first direction (as indicated by the arrow illustrated in FIG. 1) and the lock mechanism 102 may prevent the rail 120 from moving in a second direction (as indicated by the arrow illustrated in FIG. 1). A reverse operation of the lock mechanism 102 is contemplated as well. The details of the lock mechanism 102 are further described below.

In one aspect, the lock mechanism 102 may be configured as a ratchet. In this regard, the lock mechanism 102 may be configured such that it allows continuous linear motion in only one direction while preventing motion in the opposite direction. The lock mechanism 102 may be formed of a metallic material such as steel, aluminum, titanium, or the like. The lock mechanism 102 may additionally or alternatively be formed of a synthetic material such as a plastic, or the like. The lock mechanism 102 may additionally or alternatively be formed of a composite material that includes carbon fiber, Kevlar fiber, glass fiber, or the like.

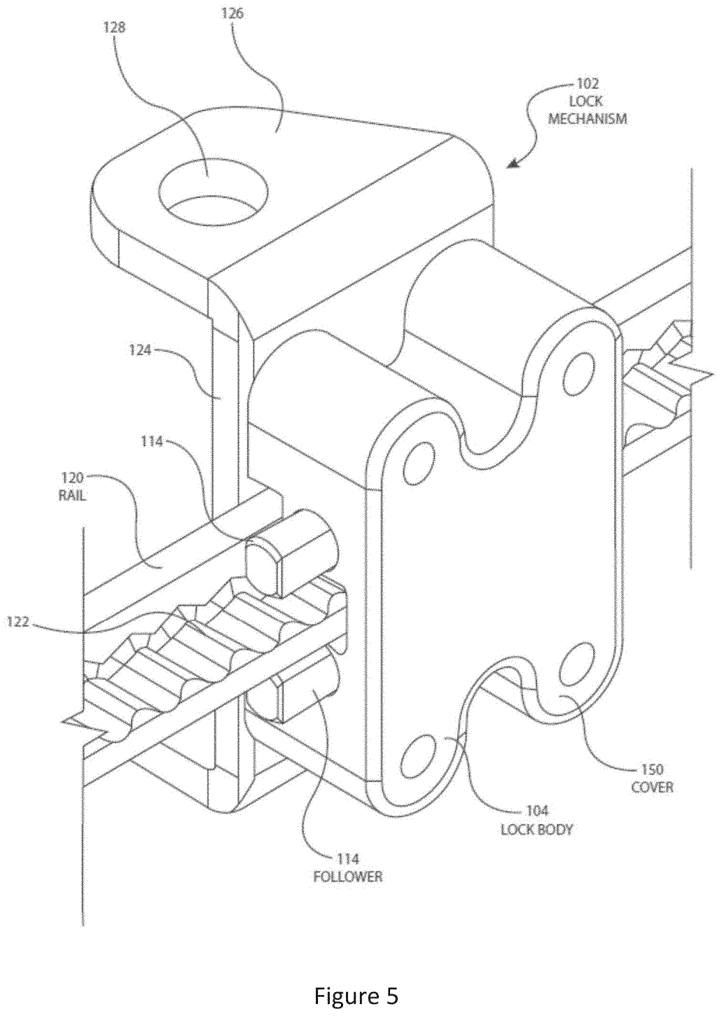

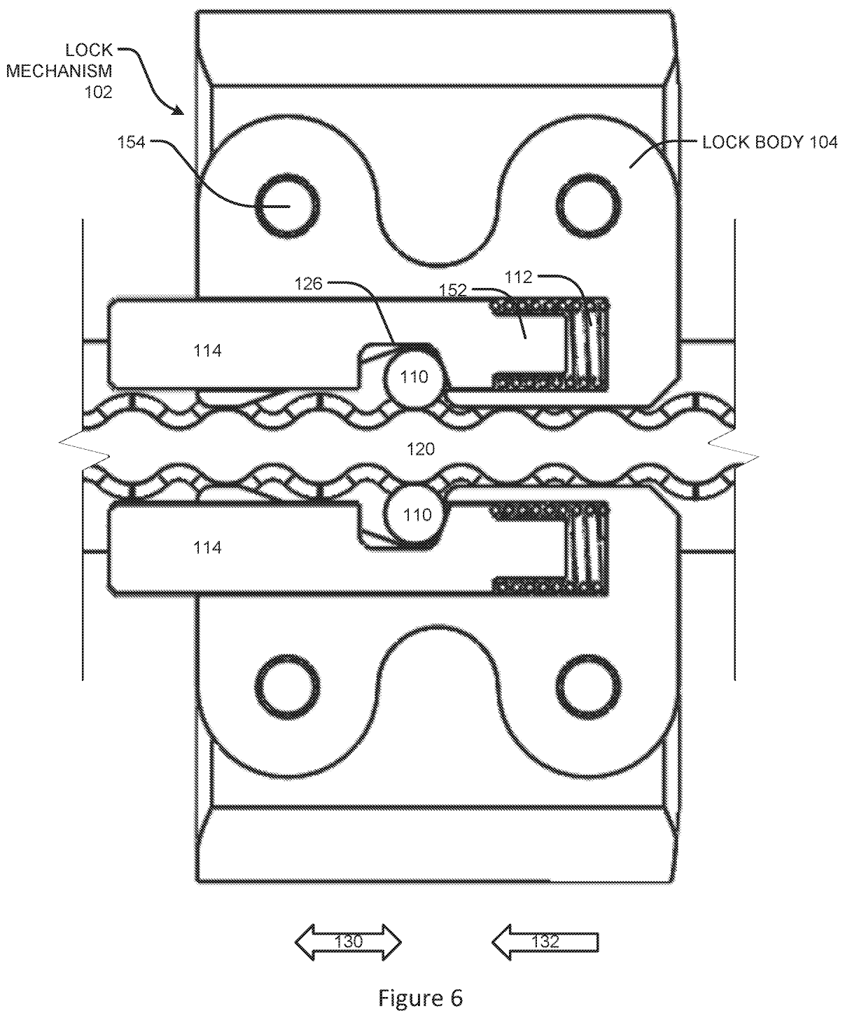

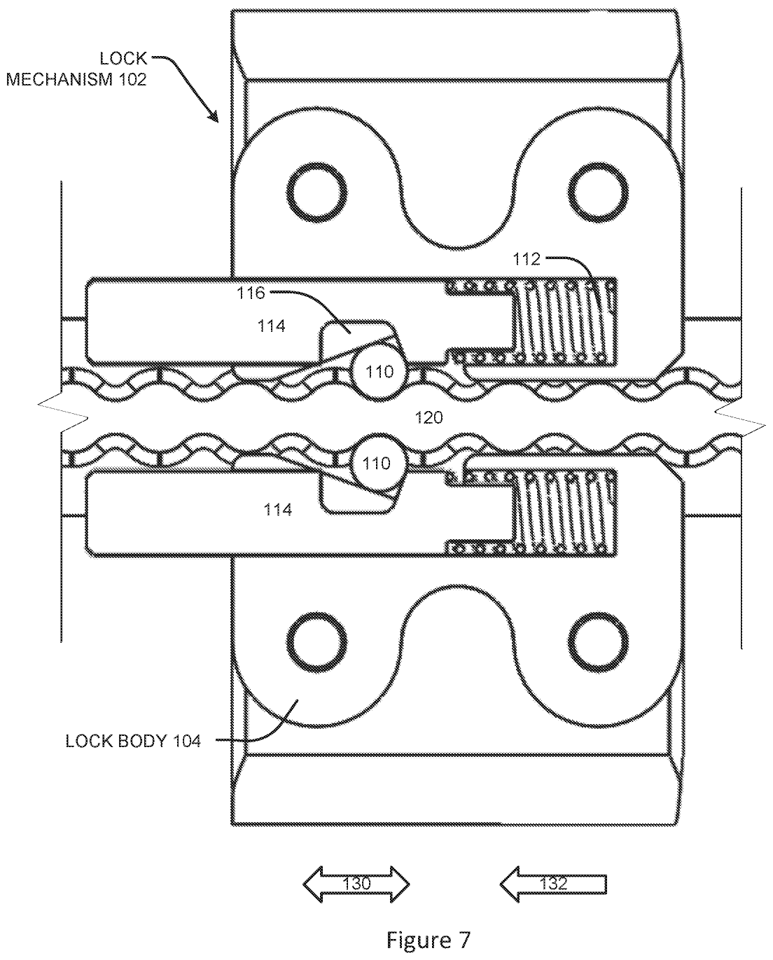

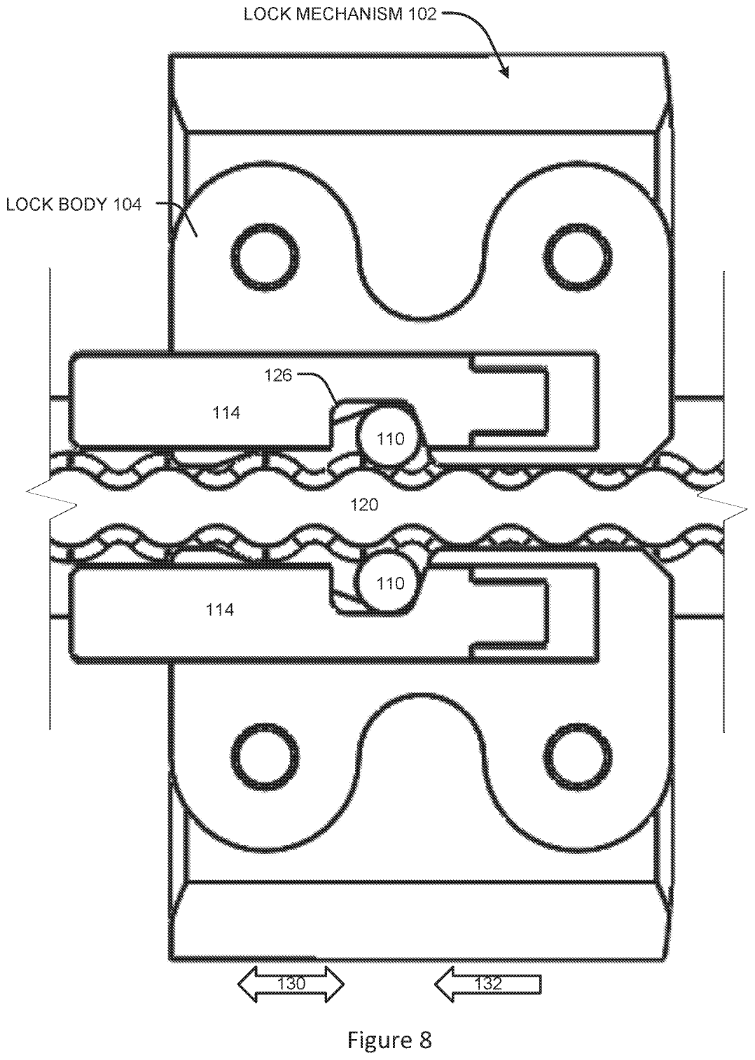

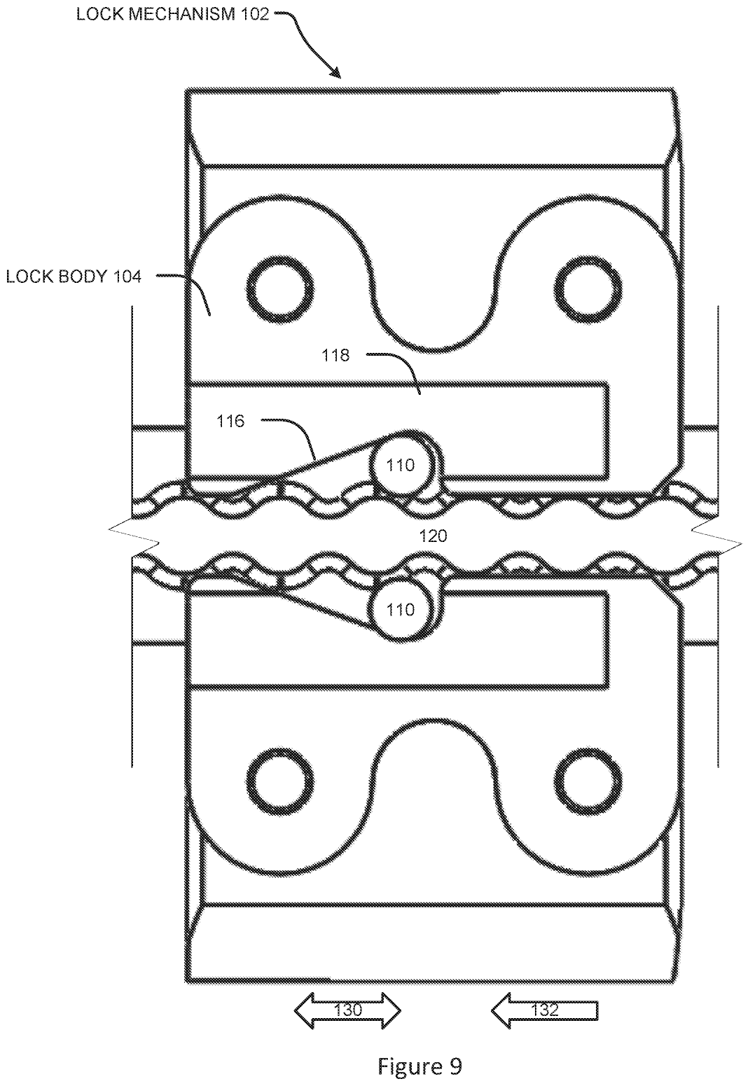

FIG. 5 illustrates a partial perspective view of a lock mechanism according to an aspect of the disclosure; FIG. 6 illustrates a partial side view of the lock mechanism of FIG. 5 in an unlocked configuration; FIG. 7 illustrates a partial side view of the lock mechanism of FIG. 5 in a locked configuration; FIG. 8 illustrates a partial side view of the lock mechanism of FIG. 5; and FIG. 9 illustrates a partial side view of the lock mechanism of FIG. 5.

In particular, FIG. 5 illustrates further details of the lock mechanism 102. The lock mechanism 102 may include a support bracket 124. The support bracket 124 may include a portion 146 for attachment to a structure or another component. The portion 146 may include an aperture 128 for receiving a mechanical fastener for attachment to the structure or another component. The mechanical fastener may include a bolt, screw, rivet, or the like.

The support bracket 124 may further support a lock body 104. As illustrated in FIG. 6, the lock body 104 may include one or more apertures 154 for receiving a mechanical fastener for attachment of the lock body 104 to the support bracket 124. The mechanical fastener may include a bolt, screw, rivet, or the like.

As illustrated in FIG. 5, the lock body 104 of the lock mechanism 102 may include a cover 150 that may cover the various components arranged within the lock body 104. FIG. 7, FIG. 8, and FIG. 9 illustrate the lock body 104 of the lock mechanism 102 with the cover 150 removed for ease illustration and understanding of the various components arranged within the lock body 104.

The rail 120 may include a plurality of engagement portions 122. In one aspect, the engagement portions 122 may extend generally the entire length of the rail 120. In one aspect, the engagement portions 122 may be formed of semicircular scalloped portions. In one aspect, the engagement portions 122 may be formed of semicircular scalloped portions on both an upper and lower side of the rail 120. In other aspects, the engagement portions 122 may utilize other shaped surfaces such as ramped shaped surfaces, polygonal shaped surfaces, triangular shaped surfaces, and/or the like.

With reference to FIG. 6, FIG. 7, FIG. 8, and FIG. 9, the lock mechanism 102 may further include a locking component such as at least one roller pin 110. In one aspect, the at least one roller pin 110 engages the engagement portions 122 on one side of the rail 120. In one aspect, the lock mechanism 102 may include at least two of the roller pins 110. In one aspect, the at least two of the roller pins 110 may engage the engagement portions 122 on both sides of the rail 120.

The least one roller pin 110 may be configured as a generally cylindrical structure. However, other shaped structures may be utilized as well including spherical structures. The at least one roller pin 110 may be formed of a metallic material such as steel, aluminum, titanium, or the like. The at least one roller pin 110 may additionally or alternatively be formed of a synthetic material such as a plastic, or the like. The at least one roller pin 110 may additionally or alternatively be formed of a composite material that includes carbon fiber, Kevlar fibers, glass fiber, or the like.

In one aspect, the lock mechanism 102 utilizing the roller pins 110 and the engagement portions 122 may provide no resistance to movement of the rail 120 in the first direction. In one aspect, the lock mechanism 102 utilizing the roller pins 110 and the engagement portions 122 may provide resistance to movement of the rail 120 in the second direction. In other words, the lock mechanism 102 may lock movement of the rail 120 in the second direction; and the lock mechanism 102 may allow movement of the rail 120 in the first direction.

With reference to FIG. 6, the lock body 104 may include a follower 114. The follower 114 may be located in a slot 118 of the lock body 104 as illustrated in FIG. 9. In this regard, FIG. 9 illustrates the lock body 104 without the follower 114 for ease of understanding. In one aspect, the slot 118 may be at least partially cylindrical. The follower 114 may be formed of a metallic material such as steel, aluminum, titanium, or the like. The follower 114 may additionally or alternatively be formed of a synthetic material such as a plastic, or the like. The follower 114 may additionally or alternatively be formed of a composite material that includes carbon fiber, Kevlar fibers, glass fiber, or the like.

With further reference to FIG. 6, the follower 114 may further include a slotted portion 126 configured to engage the roller pin 110. In one aspect, the slotted portion 126 is configured to allow the roller pin 110 to move with respect to the rail 120 when the lock mechanism 102 is in an unlocked state. In one aspect, the slotted portion 126 is configured to allow the roller pin 110 to move with respect to the rail 120 when the rail 120 is moving in the first direction. In one aspect, the slotted portion 126 is configured to prevent the roller pin 110 from moving with respect to the rail 120 when the lock mechanism 102 is in a locked state. In one aspect, the slotted portion 126 is configured to prevent the roller pin 110 from moving with respect to the rail 120 when the rail 120 is moving in the second direction. In one aspect, the slotted portion 126 may include a generally horizontal or horizontal surface, a generally vertical or vertical surface, and an inclined surface. In one aspect, the generally horizontal or horizontal surface may be connected to both the generally vertical or vertical surface, and the inclined surface. In one aspect, the generally horizontal or horizontal surface may be connected by curved surfaces to both the generally vertical or vertical surface, and the inclined surface.

The follower 114 may be configured to move in the direction of arrow 130 as illustrated in FIG. 6. In this regard, the follower 114 may be configured to move only a limited distance within the lock body 104 in the direction of arrow 130. In particular, the follower 114 may be configured to move back and forth within the lock body 104 in the direction of arrow 130.

The follower 114 may further include a portion 152 configured to receive and engage a spring 112. In one aspect, the follower 114 may be generally cylindrical with flat sides. In one aspect, the portion 152 may be generally cylindrical with flat sides. In one aspect, the portion 152 may be generally cylindrical with a diameter smaller than that of the follower 114. In one aspect, the follower 114 may be generally cylindrical. In one aspect, the portion 152 may be generally cylindrical. In one aspect, the portion 152 may be generally cylindrical with a diameter smaller than that of the follower 114. Other shapes for the follower 114 and a portion 152 are contemplated as well.

The spring 112 may be configured to bias or apply force to the follower 114 in the direction of arrow 132 to urge the follower 114 in the direction of arrow 132. The spring 112 may further urge the follower 114 to contact the roller pin 110 against the slotted portion 126 to move the roller pin 110 in the direction of arrow 132.

FIG. 9 illustrates the lock body 104 without the follower 114 and without the spring 112 for ease of illustration and understanding. With reference to FIG. 9, the lock body 104 may include a ramp portion 116. The ramp portion 116 may be located internally to the lock body 104 adjacent the rail 120. In one aspect, the lock body 104 may include at least two ramp portions 116 with a ramp portion 116 located on each side of the rail 120. The ramp portion 116 may include an inclined portion extending from one surface of the lock body 104 outwardly. The inclined portion may connect to a curved portion that extends inwardly back to the one surface of the lock body.

The ramp portion 116 and the follower 114 may engage a surface of the roller pin 110 to move the roller pin 110 left or right (parallel to the direction of arrow 130). When the roller pin 110 is located in a rightmost position as illustrated in FIG. 6, the roller pin 110 may move vertically up and down within the ramp portion 116 to allow the rail 120 to move in the first direction. In particular, as the roller pin 110 moves vertically toward the follower 114, in response to an elevated area of the engagement portion 122, the roller pin 110 may engage the slotted portion 126 of the follower 114 and move the follower 114 to the right compressing the spring 112. Then, the roller pin 110 may move vertically away from the follower 114 in response to a recessed area of the engagement portion 122 and the slotted portion 126 of the follower 114 biased by the spring 112 moving the roller pin 110 into the recessed area of the engagement portion 122. In one aspect, these actions provide a ratcheting functionality of the lock mechanism 102.

When the follower 114 is located in a left position as illustrated in FIG. 7, the roller pin 110 may not move vertically up and down within the slotted portion 126 and this may prevent the rail 120 from moving in the second direction. In this regard, the engagement portions 122, the ramp portion 116, and the roller pin 110 may create a mechanical interference in addition to a frictional resistance to prevent the rail 120 from moving in the second direction. In particular, the ramp portion 116 that includes the inclined portion extending from one surface of the lock body 104 outwardly may be located horizontally to prevent the roller pin 110 from moving vertically.

In operation, the hold open rod 100 including the rail 120, the lock mechanism 102, and the like may be held in a static non-moving configuration. In this regard, the hold open rod 100 may be attached to a structure at the first attachment end 106 and/or the second attachment end 108. Additionally, the lock mechanism 102 may be attached to another structure. One of the structures may be movable and when one of the structures is moved in the first direction from an original position, the lock mechanism 102 may allow the rail 120 to move in the first direction to allow the movable structure to move. With reference to FIG. 6, the lock mechanism 102 may be in the unlocked movable state. As illustrated in FIG. 6, the roller pins 110 in conjunction with the follower 114, the ramp portion 116, and the like may allow the roller pins 110 to move vertically up and down and allow movement of the rail 120 in the first direction.

Once movement of the movable structure has stopped, the lock mechanism 102 may prevent the rail 120 from allowing the movable structure to return to its original position. In this regard, with reference to FIG. 7, the spring 112 urges the follower 114 together with the ramp portion 116 to press the roller pins 110 against the rail 120 and the engagement portions 122 to lock movement of the rail 120 in the second direction.

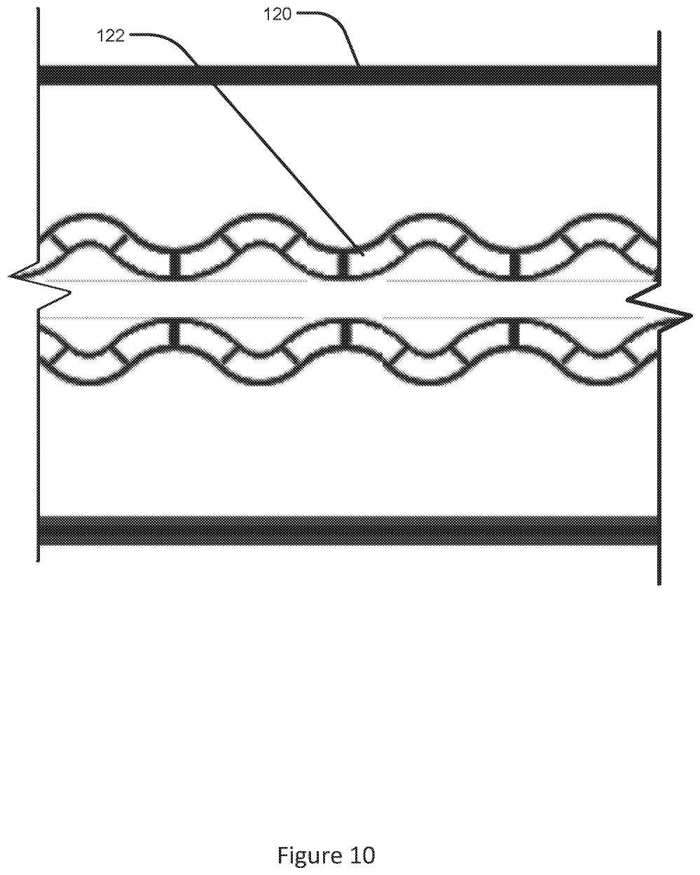

FIG. 10 illustrates a partial top view of a rail according to an aspect of the disclosure.

In particular, FIG. 10 illustrates a top view of the rail 120 and the engagement portions 122. In the aspect of FIG. 10, the engagement portions 122 may be arranged symmetrically on either side of the rail 120. Additionally, FIG. 10 illustrates that the engagement portions 122 may be formed of semicircular scalloped portions. In other aspects, the engagement portions 122 may utilize other shaped surfaces such as ramped shaped surfaces, polygonal shaped surfaces, triangular shaped surfaces, and/or the like.

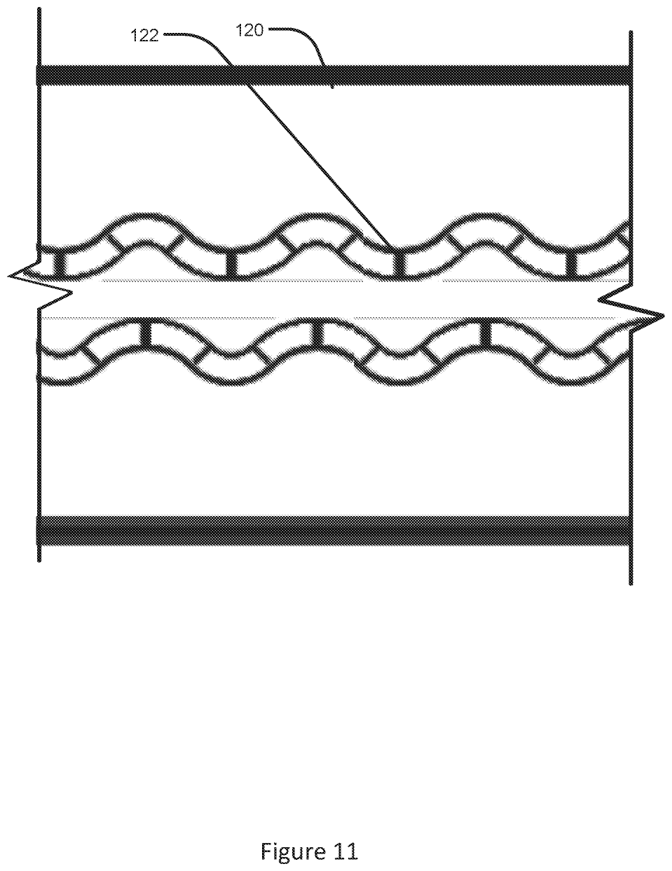

FIG. 11 illustrates a partial top view of a rail according to another aspect of the disclosure.

In particular, FIG. 11 illustrates a top view of the rail 120 and the engagement portions 122. In the aspect of FIG. 11, the engagement portions 122 may be arranged offset with respect to one another on either side of the rail 120. This arrangement provides a different locking functionality as the lock mechanism 102 may lock on either one of the engagement portions 122 to provide a finer degree of positioning of the hold open rod 100 in a locked open position.

FIG. 12 illustrates a hold open rod system according to an aspect of the disclosure.

In one aspect, the hold open rod 100 may be configured with an additional hold open rod 200 to form a hold open rod system 202 were the additional hold open rod 200 includes a locking mechanism 218. In particular, FIG. 12 illustrates a hold open rod system 202. The hold open rod system 202 may include the additional hold open rod 200 having an inner tube 212 and an outer tube 214. The outer tube 214 may at least partially surround the inner tube 212. One end of the additional hold open rod 200 may include a fastener portion 216 for coupling the additional hold open rod 200 to a particular application, for example, an aircraft door, a door frame, or the like (not shown). The fastener portion 216 may include one or more apertures for receiving a mechanical fastener for attachment of the hold open rod system 202 to the particular application. The mechanical fastener may include a bolt, screw, rivet, or the like. In further aspects, the hold open rod system 202 may include more than two tubes each telescoping into the other. However, for brevity and ease of understanding, the hold open rod system 202 will be described in the disclosure and illustrated with respect to a two-rod implementation of the hold open rod system 202.

The additional hold open rod 200 and/or the locking mechanism 218 may be implemented a number of different ways. In one aspect, the additional hold open rod 200 and/or the locking mechanism 218 may be implemented consistent with U.S. patent application Ser. No. 14/663,227, filed Mar. 19, 2015 (title—“Pull Then Lift Lock Mechanism”) owned by the assignee of the disclosure and incorporated by reference herein in its entirety.

In one aspect, the additional hold open rod 200 and/or the locking mechanism 218 may be implemented consistent with U.S. patent application Ser. No. 12/857,947, filed Aug. 17, 2010 (title—“Mechanically Dampening Hold Open Rod”) owned by the assignee of the disclosure and incorporated by reference herein in its entirety.

In one aspect, the additional hold open rod 200 and/or the locking mechanism 218 may be implemented consistent with U.S. patent application Ser. No. 13/323,355, filed Dec. 12, 2011 (title—“Carbon Fiber Hold Open Rod”) owned by the assignee of the disclosure and incorporated by reference herein in its entirety.

In one aspect, the additional hold open rod 200 and/or the locking mechanism 218 may be implemented consistent with U.S. patent application Ser. No. 13/314,982, filed Dec. 8, 2011 (title—“Reinforced Plastic Locking Dogs”) owned by the assignee of the disclosure and incorporated by reference herein in its entirety.

In one aspect, the additional hold open rod 200 and/or the locking mechanism 218 may be implemented consistent with U.S. patent application Ser. No. 13/397,320, filed Feb. 15, 2012 (title—“Hold Open Rod Vibration Dampening System”) owned by the assignee of the disclosure and incorporated by reference herein in its entirety.

In one aspect, the additional hold open rod 200 and/or the locking mechanism 218 may be implemented consistent with U.S. patent application Ser. No. 13/345,239, filed Jan. 6, 2012 (title—“Internal Locking Mechanism For A Hold Open Rod”) owned by the assignee of the disclosure and incorporated by reference herein in its entirety.

In one aspect, the hold open rod 100 may be connected to a “pressure relief door,” which needs to have nearly no resistance to opening. As described herein, the hold open rod 100 may be configured to provide no resistance to opening the pressure relief door. Additionally, the hold open rod 100 may be configured with the lock mechanism 102 to prevent the pressure relief door from slamming or returning back to a closed configuration after it opens. In this regard, the lock mechanism 102 as described herein is configured to utilize a ratcheting type of lock mechanism for the hold open rod 100 to move to an open position and be locked in the open position.

In one aspect, the pressure relief door may be associated with a power plant. For example, the power plant may include a turbine jet engine, a high bypass turbo fan, a turboprop engine, a helicopter turbine engine, an auxiliary power unit turbine engine, and/or the like. During certain failures of the power plant, an associated pressure relief door may be utilized to relieve pressure within the power plant and it may be beneficial to maintain the pressure relief door in an open position. In the open position, the pressure relief door may be subjected to extreme aerodynamic forces as it may extend into the airstream. This open position being maintained by the hold open rod 100 and associated lock mechanism 102 to increase safety for an associated aircraft. Additionally, other implementations for an aircraft are contemplated. For example, an aircraft may include a number of other components that may utilize the hold open rod 100 to hold open components associated with a fuselage, wings, an empennage, landing gear, a powerplant, control surfaces, and the like, each of which may include doors, structures, and/or the like that may benefit from implementation of the hold open rod 100 at described herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A hold open rod comprising:
a rail configured to be attached to a structure;
the rail comprising at least one surface having engagement portions;
a lock mechanism configured to be attached to the rail, the lock mechanism configured to allow the rail to move in a first direction; and
the lock mechanism configured to prevent the rail from moving in a second direction by engaging with the engagement portions.

2. The hold open rod of claim 1, wherein the lock mechanism comprises at least one roller pin.

3. The hold open rod of claim 2, wherein:
the at least one roller pin is configured to contact the engagement portions;
the at least one roller pin is configured to allow the rail to move in a first direction; and
the at least one roller pin is configured to prevent the rail from moving in a second direction.

4. The hold open rod of claim 1, wherein:
the lock mechanism comprises a lock body, at least one roller pin, at least one ramp, and at least one follower;
the at least one follower and the at least one ramp being configured in one configuration to limit movement of the at least one roller pin with respect to the engagement portions; and
the at least one follower and the at least one ramp configured in a second configuration to allow movement of the at least one roller pin with respect to the engagement portions.

5. The hold open rod of claim 1, wherein:
the lock mechanism comprises a lock body, at least one roller pin, at least one ramp, and at least one follower;
the at least one roller pin is configured to contact the engagement portions;
the at least one roller pin is configured to allow the rail to move in a first direction;
the at least one roller pin is configured to prevent the rail from moving in a second direction;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

6. The hold open rod of claim 1, wherein:
the lock mechanism comprising a lock body, at least one roller pin, at least one ramp, and at least one follower;
the at least one roller pin configured to contact the engagement portions;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

7. The hold open rod of claim 1, wherein:
the lock mechanism comprising a lock body, at least one roller pin, at least one ramp, and at least one follower;
the at least one roller pin configured to contact the engagement portions;
the at least one roller pin configured to allow the rail to move in a first direction;
the at least one roller pin configured to prevent the rail from moving in a second direction;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

8. A system comprising the hold open rod of claim 1, the system further comprising:
an additional hold open rod member, the additional hold open rod member comprising:
an inner member; and
an outer member configured to have the inner member slide in and out of the outer member.

9. The system of claim 8 wherein:
the additional hold open rod member comprising a locking mechanism configured to selectively lock the inner member and outer member with respect to each other.

10. The hold open rod of claim 1, wherein the hold open rod is attached to an aircraft component.

11. A hold open rod comprising:
a rail configured to be attached to a structure;
the rail comprising at least one surface having engagement portions;
a ratcheting lock mechanism configured to be attached to the rail, the ratcheting lock mechanism configured to allow the rail to move in a first direction; and
the ratcheting lock mechanism configured to prevent the rail from moving in a second direction by engaging with the engagement portions.

12. The hold open rod of claim 11, wherein the ratcheting lock mechanism comprises at least one roller pin.

13. The hold open rod of claim 12, wherein:
the at least one roller pin is configured to contact the engagement portions;
the at least one roller pin is configured to allow the rail to move in a first direction; and
the at least one roller pin is configured to prevent the rail from moving in a second direction.

14. The hold open rod of claim 11, wherein:
the ratcheting lock mechanism comprises a lock body, at least one roller pin, at least one ramp, and at least one follower;
the at least one follower and the at least one ramp being configured in one configuration to limit movement of the at least one roller pin with respect to the engagement portions; and
the at least one follower and the at least one ramp configured in a second configuration to allow movement of the at least one roller pin with respect to the engagement portions.

15. The hold open rod of claim 11, wherein:
the ratcheting lock mechanism comprises a lock body, at least one roller pin, at least one ramp, and at least one follower;
the at least one roller pin is configured to contact the engagement portions;
the at least one roller pin is configured to allow the rail to move in a first direction;
the at least one roller pin is configured to prevent the rail from moving in a second direction;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

16. The hold open rod of claim 11, wherein:
the ratcheting lock mechanism comprising a lock body, at least one roller pin, at least one ramp, and at least one follower;
the at least one roller pin configured to contact the engagement portions;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

17. The hold open rod of claim 11, wherein:
the ratcheting lock mechanism comprising a lock body, at least one roller pin, at least one ramp, and at least one follower;
the at least one roller pin configured to contact the engagement portions;
the at least one roller pin configured to allow the rail to move in a first direction;
the at least one roller pin configured to prevent the rail from moving in a second direction;
the at least one follower and the at least one ramp configured in one configuration to limit movement of the at least one roller pin with respect to the engagement portions; and
the at least one follower and the at least one ramp configured in a second configuration to allow movement of the at least one roller pin with respect to the engagement portions.

18. A system comprising the hold open rod of claim 11, the system further comprising:
an additional hold open rod member, the additional hold open rod member comprising:
an inner member; and
an outer member configured to have the inner member slide in and out of the outer member.

19. The system of claim 18 wherein:
the additional hold open rod member comprising a locking mechanism configured to selectively lock the inner member and outer member with respect to each other.

20. The hold open rod of claim 11, wherein the hold open rod is attached to an aircraft component.
